(19) United States
(12) Patent Application Publication
(10) Pub. No.: US 2014/0160747 A1
(43) Pub. Date: Jun. 12, 2014

(54) INTER-CONNECTABLE MODULAR LIGHTING FIXTURES

(71) Applicant: Samsung Electronics Co., Ltd., Suwon-si (KR)

(72) Inventors: June JANG, Seoul (KR); Ki Un LEE, Hwaseong-si (KR)

(73) Assignee: SAMSUNG ELECTRONICS CO., LTD., Suwon-si (KR)

(21) Appl. No.: 14/013,379

(22) Filed: Aug. 29, 2013

(30) Foreign Application Priority Data
Dec. 10, 2012 (KR) 10-2012-0142997

(51) Int. Cl. F21S 8/04

(52) U.S. Cl. CPC F21S 8/046
USPC 362/235

(57) ABSTRACT

A lighting fixture includes a frame having a short protrusion disposed in an outer surface of the frame, the short protrusion having a step structure. At least one light source is disposed inside the frame, and a cover is coupled to the frame to cover the at least one light source. A pair of cap parts each include a coupling groove and supply power to the light source and are each disposed at a respective end of the frame. A terminal part has one end fastened to the coupling groove of one of the pair of cap parts, and has the other end protruding to the outside.

### CROSS-REFERENCE TO RELATED APPLICATION

This application claims priority from Korean Patent Application No. 10-2012-0142997, filed on Dec. 10, 2012 in the Korean Intellectual Property Office, the disclosure of which is incorporated herein by reference in its entirety.

### TECHNICAL FIELD

The disclosure relates to inter-connectable modular lighting fixtures for use in lighting systems.

### BACKGROUND

A large number of different types of fluorescent light fixtures are currently available. Each light fixture type is fixed differently, making it difficult to apply standardization to the lighting fixtures.

Lighting apparatuses that use light emitting diodes (LEDs) as light sources are being developed to replace or substitute for older lighting apparatuses. The substitute lighting apparatuses may be classified as L-tube lighting apparatuses used to replace existing fluorescent lighting fixtures, flat lighting apparatuses using embedded lighting fixtures, and the like.

Since lighting fixtures have different forms, flexibility in installing and replacing lighting fixtures may be deteriorated when lighting fixtures are mounted. Further, a defect in which a dark portion occurs in a location of a connecting part between adjacent lighting fixtures may occur.

### SUMMARY

An aspect of an embodiment provides a lighting fixture capable of significantly reducing the occurrence of a dark portion occurring in a location of connecting portions between a plurality of lighting fixtures.

An aspect of an embodiment also provides a lighting fixture to which various fixing schemes can be applied with respect to a location, such as a ceiling, to which a lighting fixture is fixed.

According to an aspect of the present inventive concept, there is provided a lighting fixture comprising: a frame including a short protrusion disposed in an outer surface of the frame, the short protrusion having a step structure; at least one light source disposed inside the frame; a cover coupled to the frame to cover the at least one light source; a pair of cap parts each including a coupling groove and supplying power to the at least one light source and each disposed at a respective end of the frame; and a terminal part having one end fastened to the coupling groove of one of the pair of cap parts and having the other end protruding to the outside.

The terminal part of the lighting fixture may be further fastened to a coupling groove of a different lighting fixture through the other end of the terminal part that protrudes to the outside, to thereby connect the lighting fixture and the different lighting fixture to one another.

The lighting fixture may further include at least one clip part engaged with the short protrusion and configured to be detachably fastened to the frame.

The short protrusion may protrude from an upper surface of the frame and extend in a length direction of the frame, and the clip part may include a protrusion caught by and fixed to the short protrusion provided in the length direction of the frame.

The clip part may include a first surface disposed above the short protrusion when the clip part engages the short protrusion, and a second surface bent away from both ends of the first surface and extending therefrom.

The second surface may include a pair of second surfaces extending away from the first surface in parallel with each other and each having a protrusion formed on an inner surface facing the each other second surface of the pair.

The lighting fixture may further include a third surface bent outward from respective edges of the pair of second surfaces so as to be disposed along the upper surface of the frame when the clip part engages the short protrusion.

The frame may include a base part having one surface on which the short protrusion is disposed and another surface on which the light source is disposed. The frame may also include a reflective part bent from an outer edge of the base part and extended therefrom.

The short protrusion may have a rail structure in which at least one pair of protrusions protrude symmetrically outward from opposite side surfaces of the short protrusion, and may extend in the length direction of the base part.

Each cap part may include the cap coupled to a respective distal end of the frame and having a coupling groove therein. Each cap part may also include an electrode pin included in the coupling groove and connected to the terminal part.

The light source may include at least one substrate and at least one light emitting device disposed on the substrate.

According to an aspect of the present disclosure, there is provided alighting fixture including: a frame including a short protrusion disposed on an outer surface of the frame, the short protrusion having a step structure; at least one light source disposed inside the frame; a cover coupled to the frame to cover the at least one light source; a pair of connector parts each coupled to a respective distal end portion of the frame, and one connector part of the pair including a male connector and the other connector part of the pair including a female connector having a structure in which the female connector can be engaged with a male connector of another lighting fixture; and a clip part engaged with the short protrusion so as to detachably fasten the clip part to the frame.

The male connector may include a support portion protruding laterally from the connector part and a step portion extending orthogonally to the support portion at an edge of the support portion, and the female connector may include a groove portion having a shape complementary to the shape of the support portion and the step portion of the male connector.

The male connector and the female connector may each include an electrode pin disposed thereon and exposed to the outside, and the electrode pin of the female connector of the lighting fixture may be engaged with the electrode pin of the male connector of the other lighting fixture such that the female connector and the male connector are electrically connected.

The clip part may be simultaneously fastened to the frame of the lighting fixture and to the frame of the other lighting fixture, such that the lighting fixture and the other lighting fixture may be fixed to each other.

According to another aspect of the present disclosure, there is provided a lighting system including: first and second lighting apparatuses, wherein each of the first and second lighting apparatuses comprises: a frame including a short protrusion disposed in an outer surface of the frame, the short protrusion having a step structure; a light source disposed inside the frame; and a pair of cap parts, each including a coupling groove and supplying power to the light source of the respective lighting apparatus, and each disposed at a respective end of the frame; and a clip part engaged with the short protrusion of the first lighting apparatus and with the short protrusion of the second lighting apparatus, including a fixing hole for fastening the clip part to a structure, and configured to detachably fasten the frames of the first and second lighting apparatuses to each other and to the structure.

The short protrusion of each of the first and second lighting apparatuses may protrude from an upper surface of the frame of the respective lighting apparatus and may extend in a length direction of the frame, and the clip part may include a protrusion caught by and fixed to the short protrusion of each of the first and second lighting apparatuses provided in the length direction of the frame.

The clip part may further include a first surface disposed above the short protrusion of each of the first and second lighting apparatuses when the clip part engages the short protrusion of the first and second lighting apparatuses, and a second surface bent away from both ends of the first surface and extending therefrom.

The second surface of the clip part may include a pair of second surfaces extending away from the first surface in parallel with each other and each having a protrusion formed on an inner surface facing the other second surface of the pair.

The clip part may include a third surface bent outward from respective edges of the pair of second surfaces so as to be disposed along the upper surface of the frame of each of the first and second lighting apparatuses when the clip part engages the short protrusion of the first and second lighting apparatuses.

### BRIEF DESCRIPTION OF THE DRAWINGS

The above and other aspects, features and other advantages will be more clearly understood from the following detailed description taken in conjunction with the accompanying drawings, in which:

FIG. 1 is an exploded perspective view of a lighting fixture according to an embodiment;

FIG. 2 is a cross-sectional view of a frame shown in FIG. 1;

FIG. 3 is a schematic perspective view of a short protrusion included in the frame of FIG. 1;

FIGS. 4A to 4D are schematic cross-sectional views illustrating various embodiments of a cover shown in FIG. 1;

FIGS. 5A and 5B are schematic cross-sectional views illustrating various fixing schemes for the lighting fixture using a clip part of FIG. 1;

FIGS. 6A and 6B are schematic cross-sectional views illustrating another embodiment of the clip part shown FIG. 5 and a fixing scheme implemented thereby;

FIG. 7 is a schematic perspective view of a lighting system obtained by connecting a plurality of lighting fixtures of FIG. 1;

FIG. 8 is a schematic perspective view illustrating a structure in which the plurality of lighting fixtures of FIG. 7 are connected by a terminal part;

FIGS. 9A and 9B are a schematic perspective view and a side view illustrating a state in which a clip part is installed in the lighting system of FIG. 7;

FIG. 10 is a schematic perspective view of a terminal part according to another embodiment of the lighting emitting of FIG. 8;

FIG. 11 is a cross-sectional view of the terminal part shown in FIG. 10;

FIG. 12 is a graph illustrating brightness of a lighting fixture in a state in which the lighting fixture is connected;

FIGS. 13A and 13B are schematic plan views of a lighting system implemented by connecting a plurality of lighting fixtures according to an embodiment; and

FIG. 14 is a side view schematically illustrating a separating scheme in which individual lighting fixtures among the plurality of lighting fixtures in the lighting system of FIG. 13 are separated.

### DETAILED DESCRIPTION

Embodiments will now be described in detail with reference to the accompanying drawings.

Embodiments may, however, be embodied in many different forms and should not be construed as being limited to embodiments set forth herein. Rather, these embodiments are provided so that this disclosure will be thorough and complete, and will fully convey the scope of the inventive concepts to those skilled in the art.

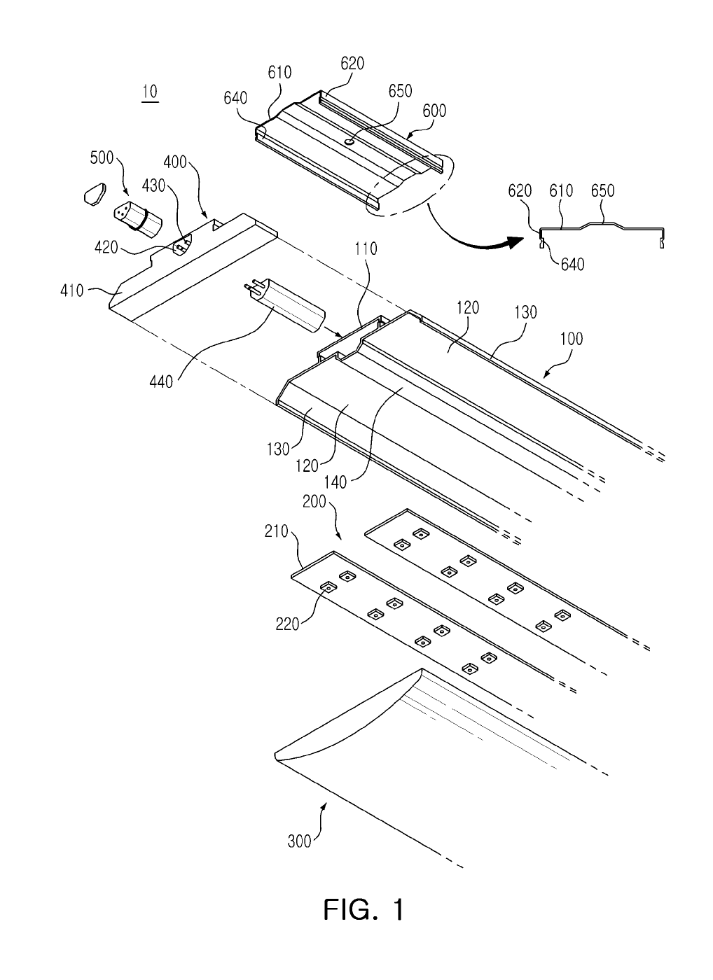

With reference to FIGS. 1 to 6, a lighting fixture according to an embodiment will be described.

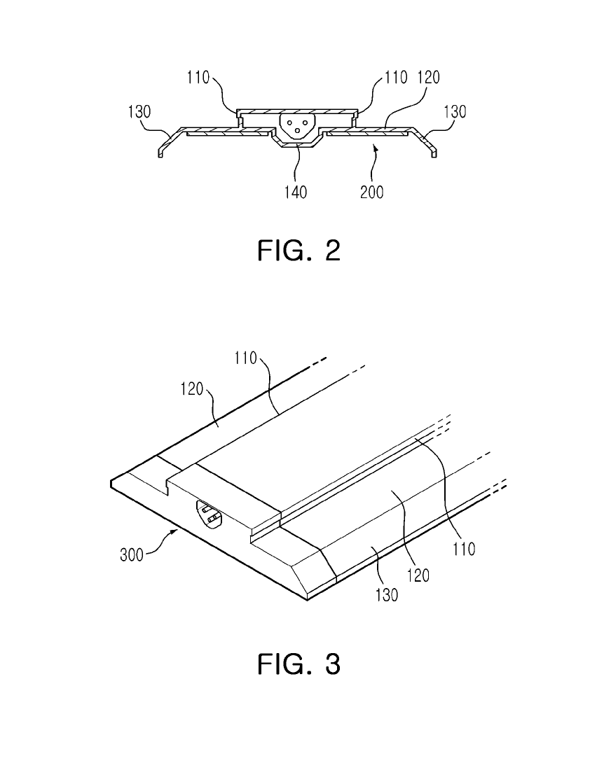

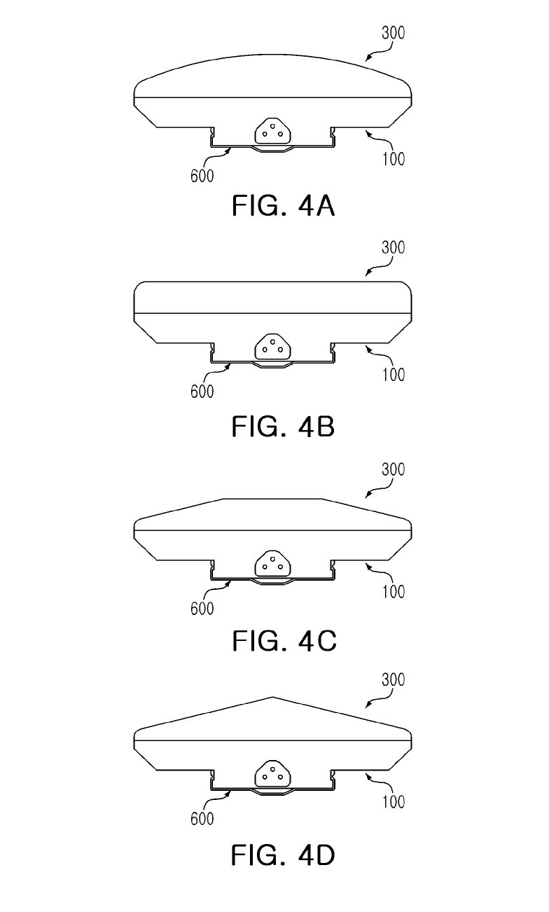

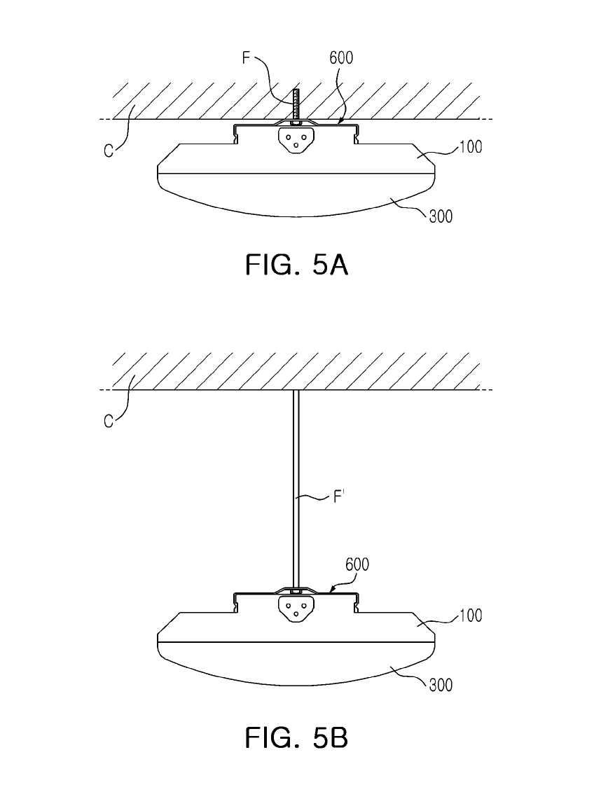

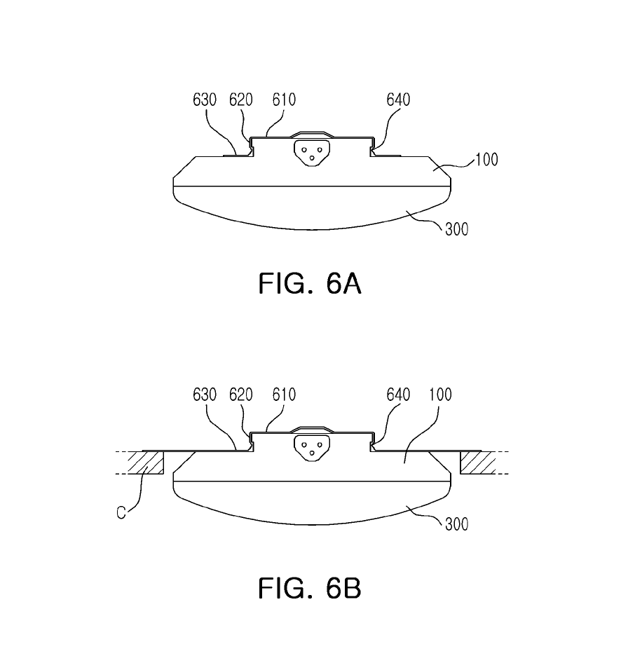

FIG. 1 is an exploded perspective view of a lighting fixture according to an embodiment, FIG. 2 is a cross-sectional view of a frame shown in FIG. 1, and FIG. 3 is a schematic perspective view of a short protrusion included in the frame of FIG. 1. FIGS. 4A to 4D are schematic cross-sectional views illustrating various embodiments of a cover shown in FIG. 1. FIGS. 5A and 5B are schematic cross-sectional views illustrating various fixing schemes applied to the lighting fixture through a clip part of FIG. 1. FIGS. 6A and 6B are schematic cross-sectional views illustrating another embodiment of the clip part shown in FIG. 5 and a fixing scheme implemented thereby.

With reference to FIGS. 1 to 6, a lighting apparatus according to an embodiment of the inventive concept may include a frame 100, a light source 200, a cover 300, a cap part 400 and a terminal part 500. Alighting fixture 10 may include the lighting apparatus as well as a clip part 600 detachably fastened to the frame 100.

The frame 100 may be a support structure for supporting and fixing the light source 200 installed in the frame 100, and may include a heat sink. To this end, the frame 100 may be formed of a material having excellent heat conductivity, for example, a metal, but may alternatively or additionally be formed of other materials.

The frame 100 may include a short protrusion 110 having a step structure formed in an upper outer surface of the frame. In detail, the frame 100 may include a base part 120 having a surface (e.g., an upper surface) on which the short protrusion 110 is disposed and another surface (e.g., a lower surface opposite to the upper surface) on which the light source 200 is disposed, and a reflective part 130 angled with respect to the other surface and formed of a bent portion of the base part 120 formed at an outer edge of the base part 120.

The base part 120 may have a substantially rectangular footprint structure in which the length thereof is greater than the width thereof. The reflective part 130 may be formed as a pair of reflective parts formed on opposing outer edges of the base part 120, and may be formed of a bent portion of the opposing outer edges of the base part 120 formed along the length of the base part 120. The reflective part 130 is bent at a predetermined angle of inclination with respect to a central portion of the base part 120 such that the reflective part 130 extends downwardly from the base part 120.

The base part 120 may further include an auxiliary reflective part 140 disposed in a central portion of the base part 120. The auxiliary reflective part 140 may be extended along a lengthwise direction of the base part 120, and may be positioned to be parallel to the pair of reflective parts 130. While the present embodiment includes a single auxiliary reflective part 140 located in the center of the base part 120, other embodiments may include two or more auxiliary reflective parts 140. The auxiliary reflective part 140 may be selectively provided, and in some examples, the auxiliary reflective part 140 may be omitted. In addition, the auxiliary reflective part 140 may be provided as a plurality of auxiliary reflective parts.

In the frame 100, both distal end portions thereof in the length direction may be open. The distal end portions of the frame 100 may be perpendicular to the pair of reflective parts 130.

The short protrusion 110 may protrude from an upper surface of the frame 100 and may extend in the lengthwise direction of the frame 100. In detail, the short protrusion 110 may have a rail structure including a rectangular parallelepiped base member having a pair of protrusions extending from side surfaces thereof that are symmetrically opposed to each other. The short protrusion 110 may be provided on the base part 120 and may be extended in the length direction of the base part 120. The pair of protrusions may be disposed such that one side surface of each protrusion is aligned with an upper surface of the rectangular parallelepiped base member, while a lower surface of the rectangular parallelepiped base member contacts the base part 120. The pair of protrusion are disposed on opposite sides of the rectangular parallelepiped base member such that each one extends towards a respective reflective part 130 in parallel with the respective reflective part 130.

The light source 200 may be disposed in the frame 100 and may be operative to emit light. The light source 200 may include at least one substrate 210 and at least one light emitting device 220 mounted on the substrate 210.

The substrate 210 may be a FR4 type printed circuit board (PCB) and may be formed of an organic resin material containing epoxy, triagine, silicon rubber, polyamide, or the like, and a further organic resin material. The substrate 210 may also be formed of a ceramic material such as AlN, Al₂O₃ or the like, may be formed of a metal or a metal compound, or may contain MCPCB or the like.

The substrate 210 may be fixedly mounted on the base part 120 and may be formed as a bar elongated in the length direction of the base part 120. The substrate 210 may be disposed on a lower surface of the base part 120.

The light emitting device 220 may be mounted on the substrate 210 to be electrically connected thereto. The light emitting device 220 may be a semiconductor device generating light having a predetermined wavelength in response to having external power applied thereto. The light emitting device 220 may include a light emitting diode (LED). The light emitting device 220 may emit blue light, green light, or red light depending upon a material contained therein, and may also generate white light.

While the present embodiment provides the example in which the light emitting device 220 is a single package product including an LED chip, this should not be considered to be limiting. For example, the light emitting device 220 may be an LED chip. In this case, the LED chip may be a chip on board (COB) type LED chip that may be mounted on the substrate 210 to be directly electrically connected to the substrate 210 in a flip chip bonding scheme or a wire bonding scheme.

The light emitting device 220 may be a plurality of light emitting devices, which may be arrayed on the substrate 210. In this case, the light emitting devices may be variously configured. For example, the light emitting devices may be of the same type of light emitting device as each other to generate light having the same wavelength, or may be of different types and/or generate light having different wavelengths.

The present embodiment provides the example in which light sources 200 are disposed on both sides of the auxiliary reflective part 140 in the frame 100, and have the auxiliary reflective part 140 interposed therebetween, but this should not be considered to be limiting. For example, the light source 200 may include a single light source or may also include three or more light sources.

The cover 300 may be coupled to the frame 100 to cover at least one light source 200. The cover 300 may cover the light source to protect the light source from an external environment. In addition, the cover 300 may be formed of a transparent or translucent material. The cover 300 may be formed of, for example, a resin such as a silicon resin, an epoxy resin or the like, and may also be formed of glass.

As shown in FIGS. 4A to 4D, the cover 300 may have various profiles or cross sectional shapes taken across a width direction, for example, a semicircular shape, an elliptical shape, a quadrangular shape, a triangular shape, a trapezoidal shape, or the like. These shapes may be selectively varied according to an environment in which the lighting fixture 10 is to be installed.

The cover 300 may include a light diffusion agent for allowing light emitted outwardly therefrom to be uniformly irradiated across a relatively wide region. The light diffusion agent may have a variety of grain sizes. For example, the light diffusion agent may include one or more materials selected from a group consisting of SiO₂, TiO₂, Al₂O₃ and the like.

Cap parts 400 may be provided on both ends of the frame 100 and may provide power to the at least one light source 200. In detail, the cap parts 400 may respectively include side caps 410 respectively coupled to both distal end portions of the frame 100 in the length direction thereof, the distal end portions being open and the side caps 410 having a coupling groove 420 therein; and an electrode pin 430 included in the coupling groove 420.

The side caps 410 may have a shape corresponding to a shape of a cross section of the fame 100 taken across the width of the frame 100, and may be formed of an electrically insulating material such as a resin. The side caps 410 may be coupled to respective distal end portions of the frame 100, the distal end portions being open when the side caps are not coupled thereto, to thereby define a closed internal space in the frame 100. The closed internal space has the light source 200 disposed therein, and is bounded by the pair of reflective parts 130.

The coupling groove 420 formed in the side caps 410 may include the electrode pin 430 provided therein to be electrically connected to external power. The electrode pin 430 may be electrically connected to a power supplier (PSU) 440 disposed in an inner portion of the frame 100. The electrode pin 430 may be connected to the light source 200 through the power supplier 440 to supply power to the light source 200. Although the present embodiment provides the example in which the power supplier 440 is disposed in the inner portion of the frame 100, this is not limiting. For example, the power supplier 440 may also be provided as a separate device disposed outside of the frame 100.

The terminal part 500 may have a bar shape having a predetermined length. An end of the terminal part 500 may be coupled to the coupling groove 420 and another end thereof may protrude outwardly to transfer power to the light source 200 through connection to external power. In detail, the terminal part 500 may be coupled to the side caps 410 in a manner in which approximately half of the terminal part 500 is inserted into the coupling part 420 and may thus be electrically connected to the electrode pin 430 provided with the coupling groove 420.

A remaining half of the terminal part 500 may protrude outwardly from the side caps 410 to thereby be connected to external power. In addition, the protruding portion of the terminal part 500 may be coupled to the coupling groove 420 of another lighting fixture 10. Therefore, a plurality of lighting fixtures 10 may be continuously connected to one another with relative mechanical strength, through terminal parts 500, while allowing for an electrical connection therebetween.

The clip part 600 may be engaged with the short protrusion 110 such that the clip part 600 may be detachably coupled to the frame 100. To this end, the clip part 600 may include a protrusion 640 caught or engaged by the short protrusion 110 protruding from an upper surface edge of the frame 100, the protrusion 640 being provided to as to be aligned with the frame 100 in a length direction thereof.

As shown in the drawings, the clip part 600 according to an embodiment may include a first surface 610 disposed above the short protrusion 110 when the clip part 600 and short protrusion 110 are engaged, and a second surface 620 angled or bent away from both ends of the first surface 610 and extending therefrom.

The first surface 610 may have a flat plate shape extended to cover the pair of short protrusions, so as to cover the upper surface of the short protrusion 110 and each of the pair of protrusions extending from the short protrusion 110. The first surface 610 may include a fixing groove or a fixing hole 650 formed in a central portion thereof, to be selectively fastened to a fixing unit F fixed to, for example, a ceiling C, a wall or the like. The fixing unit F may include, for example, a screw, a chain, a pipe, a cord, or the like.

As shown in FIG. 5A, the first surface 610 may be closely coupled to the ceiling C through the fixing unit F such as a screw. In this case, the frame 100 fastened to the clip part 600 may be closely fastened to the ceiling C to then be fixed thereto, for example, allowing for flat illumination.

As shown in FIG. 5B, the first surface 610 may be spaced apart from the ceiling C by a predetermined distance using a fixing unit F′ such as a chain or a cord. In this case, the frame 100 fastened to the clip part 600 may be fixed to the ceiling C in the form of a pendant such as a chandelier. As described above, various fixing schemes of the lighting fixture 10 may be relatively easily achieved through the use of the clip part 600.

The second surface 620 may be at least one pair of second surfaces. The at least one pair of second surfaces may have a structure in which the surfaces of the at least one pair of second surfaces are extended outward from the first surface 610 along lateral surfaces of the short protrusion 110 in parallel with each other toward to an upper surface of the frame 100. The at least one pair of second surfaces 620 may have protrusions 640 formed on inner surfaces thereof facing each other. The protrusions 640 may engage with the pair of protrusions of the short protrusion 110 to generate fixing force through which the clip part 600 is fixedly caught by the short protrusion 110.

The clip part 600 may be formed of a material having rigidity and elasticity, for example, a metal. The clip part 600 may include the first surface 610 and the second surface 620 formed as an integrated structure, or one body, by performing a pressing process on a metal plate having a predetermined size.

FIGS. 6A and 6B illustrate a clip part 600 according to another embodiment. As shown in FIGS. 6A and 6B, the clip part 600 may further include third surfaces 630 bent outward from respective outer edges of the second surface 620 and extended outwardly to contact the upper surface of the frame 100.

The third surfaces 630 may be respectively extended along the upper surface of the frame 100 in a width direction perpendicular to the length direction of the frame 100, that is, in a direction toward the reflective parts 130. In particular, the third surfaces 630 may be extended to have a width greater than that of the frame 100 in the width direction of the frame so as to thereby protrude outwardly of the frame 100.

The third surface 630 extended as described above may be, for example, disposed in a groove in the ceiling C or may be insertedly fixed thereto such that the lighting fixture 10 may be fixed to the ceiling C such that the lighting fixture is embedded in the ceiling C.

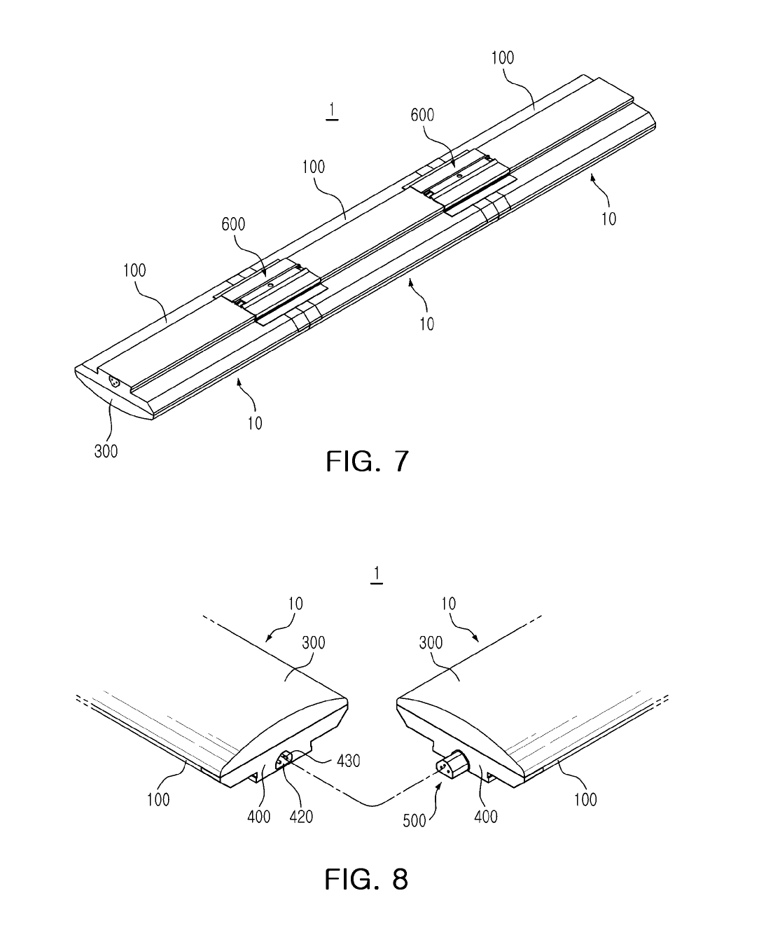

FIGS. 7 to 9 illustrate a configuration in which a plurality of lighting fixtures according to the present embodiment are connected to one another to thus form a lighting system.

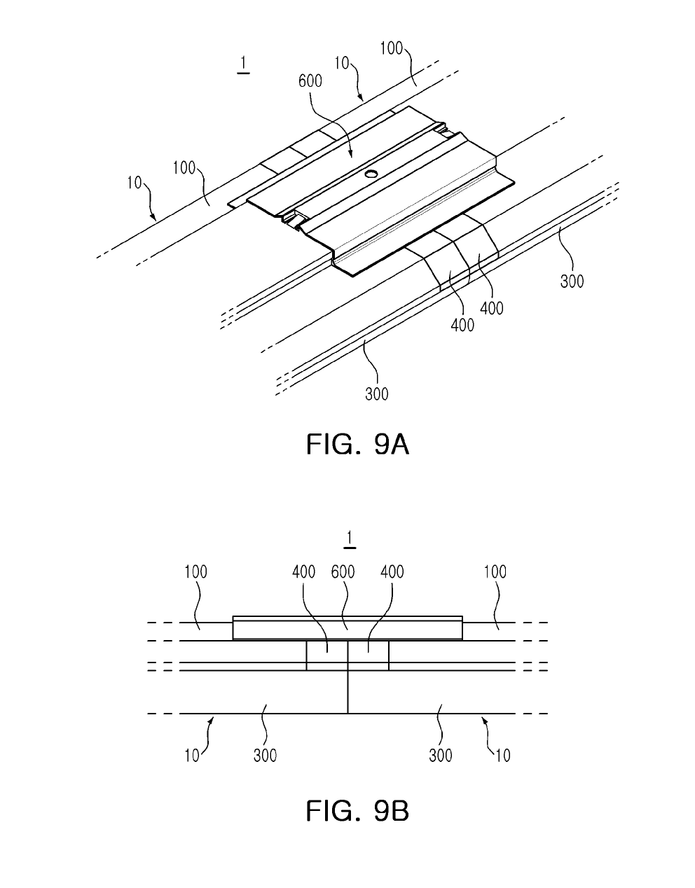

FIG. 7 is a schematic perspective view of a lighting system obtained by connecting a plurality of lighting fixtures of FIG. 1. FIG. 8 is a schematic perspective view illustrating a structure in which the plurality of lighting fixtures of FIG. 7 are connected by a terminal part. FIGS. 9A and 9B are a schematic perspective view and a side view illustrating a state in which a clip part is installed in the lighting system of FIG. 7.

As shown in FIG. 7, a lighting system 1 according to an embodiment of the inventive concept may include a plurality of lighting fixtures 10 connected to one another. The lighting fixtures 10 may be connected in series. In addition, as shown in FIG. 8, the lighting fixtures 10 may be connected to one another in such a manner that the cap parts 400 of pairs of adjacent lighting fixtures 10 contact each other through the terminal part 500, such that the lighting fixtures are arrayed in a line.

That is, the terminal part 500 may be fastened to the coupling groove 420 of a first lighting fixture 10 in a manner in which approximately half of the terminal part 500 is inserted into the coupling groove 420 and a protruding portion of the terminal part 500, other than the inserted portion thereof, is coupled to the coupling groove 420 of a different second lighting fixture 10, thereby both mechanically and electrically connecting the first and second lighting fixtures 10 to one another.

Additionally, as illustrated in FIGS . 9A and 9B, the clip part 600 may be simultaneously fastened to the respective frames 100 of each of the pair of lighting fixtures 10 connected to each other in a state in which the plurality of lighting fixtures 10 are connected in a length direction of the lighting fixture. As such, the pair of lighting fixtures 10 may be firmly fixed to each other by the clip part 600, with relative mechanical strength.

In detail, the clip part 600 may be simultaneously fastened to the frame 100 of a first lighting fixture 10 and to the frame 100 of a further second lighting fixture 10 connected thereto at a connection interface between the first and second lighting fixtures 10 which are connected to each other. That is, in the clip part 600, a portion thereof may be fastened to the frame 100 of the first lighting fixture 10 and a remaining portion thereof may be fastened to the frame 100 of the further second lighting fixture 10, such that the pair of first and second lighting fixtures 10 connected to each other may achieve relatively stable and firm mechanical strength. Accordingly, as compared to the case in which the lighting fixtures 10 are only connected through the terminal part 500, the occurrence of a gap or the like at an interface between the lighting fixtures 10 connected to each other may be prevented by using the clip part 600, and the lighting fixtures 10 may be connected relatively closer to one another, thereby achieving a seamless-connection at the interface between the lighting fixtures 10 connected to one another.

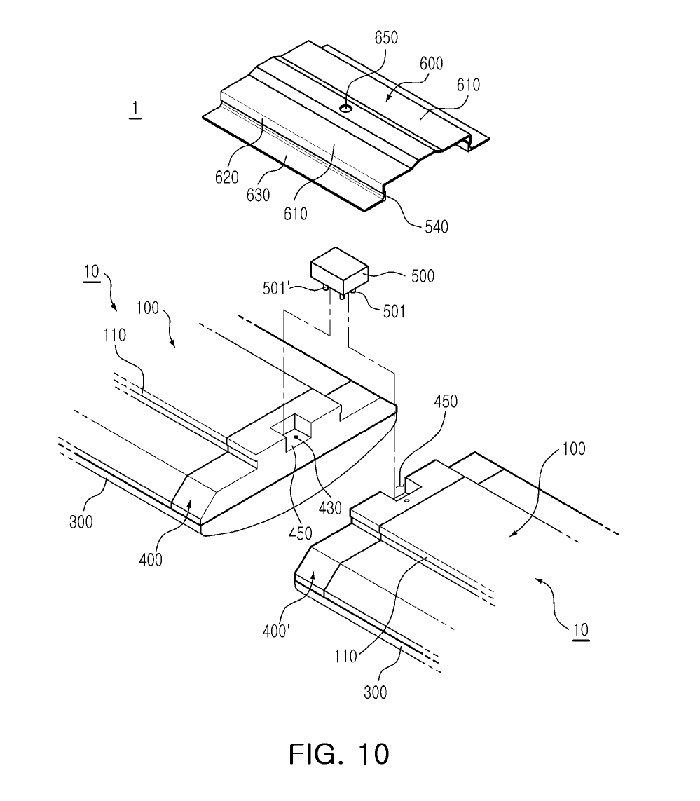

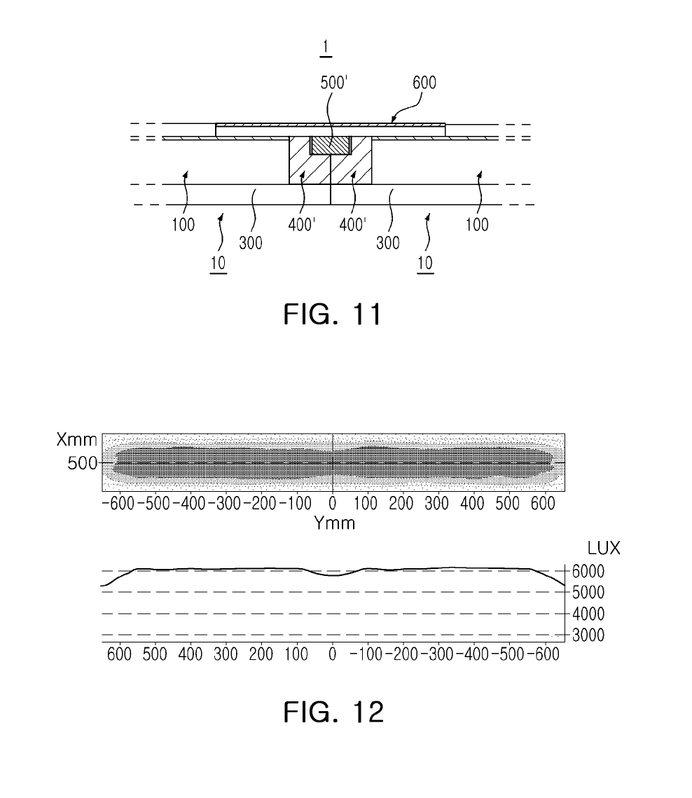

FIGS. 10 and 11 illustrate a terminal part and a cap part according to an embodiment. FIG. 10 is a schematic perspective view of a terminal part according to another embodiment of the lighting fixture of FIG. 8, and FIG. 11 is a cross-sectional view of the terminal part shown in FIG. 10.

As shown in FIG. 10, a cap part 400′ coupled to a respective distal end portion of the frame 100 may include a receiving groove 450. The receiving groove 450 may be recessed to a predetermined depth from an upper surface of the cap part 400′ to have a step structure in which the receiving groove 450 is connected to an end of the cap part 400′ . In addition, the electrode pin 430 electrically connected to the light source 200 may be exposed to the receiving groove 450.

In such a layout, in which the cap part 400′ of a lighting fixture 10 contacts the cap part 400′ of a further lighting fixture 10, a terminal part 500′ may be insertedly fitted into the receiving grooves 450 of each of the cap parts 400′ that are facing each other in a forced insertion scheme. That is, a portion of the terminal part 500′ may be insertedly fitted into the receiving groove 450 of a first lighting fixture 10, and a remaining portion, other than the inserted portion thereof, may be insertedly fitted into the receiving groove 450 of a different second lighting fixture 10, such that the pair of the first and second lighting fixtures 10, connected as described above, may be mechanically connected.

Further, the terminal part 500′ may include electrode pads 501′ contacting the exposed electrode pins 430 of a respective lighting fixture 10 when the terminal part 500′ is insertedly fitted into the receiving groove 450. Thus, the terminal part 500′ may mechanically connect the pair of lighting fixtures 10 to each other while also electrically connecting the pair of lighting fixtures 10.

The clip part 600 may be simultaneously fastened to the respective frames 100 of the pair of first and second lighting fixtures 10 connected to each other, covering the terminal part 500′ and the receiving groove 450 of both of the pair of lighting fixtures 10, such that the pair of lighting fixtures 10 may be fixed to each other with relative stability and mechanical strength.

As such, the plurality of lighting fixtures 10 may be arranged to be mutually electrically connected through the terminal part 500′, thereby achieving various types of lighting systems 1. In addition, since the terminal part 500′ is detachably fastened to the receiving groove 450 through a forced insertion scheme, in a situation in which a portion of either of the pair of lighting fixtures 10 is not workable due to occurrence of a defect, in order to replace the lighting fixture having a defect with another lighting fixture 10, the lighting fixture 10 having a defect may readily be removed downwardly. Thus, it may be easy to manage and repair the entire lighting system 1 without having to disassemble or dismount lighting fixtures 10 of the light system 1 that are still working.

In addition, at an interface in which the lighting fixtures 10 are connected to one another, the clip part 600 may be fastened to the lighting fixtures 10 such that the lighting fixtures 10 are connected relatively closer to one another. Accordingly, a seamless connection in which a gap at the interface between the lighting fixtures 10 does not occur may be implemented.

FIG. 12 is a graph illustrating brightness in a state in which two lighting fixtures 10 are connected together as in the lighting system described above. As can be confirmed in FIG. 12, the brightness is overall uniformly represented in both the lighting fixtures and at the junction of the two lighting fixtures.

In other lighting fixtures, a separated connection unit is used to provide a connection between a lighting fixture and a further lighting fixture and to mechanically connect both lighting fixtures. Such a lighting system has a discontinuous connection structure having a gap in connection portions between lighting fixtures. As a result, illumination is not uniform across the entire lighting system and brightness is deteriorated in the connection portions between lighting fixtures.

In the lighting fixture according to the embodiments shown in FIGS. 1 through 11, seamless connection at an interface in which at least two lighting fixtures 10 are connected to each other may be achieved using the terminal part 500 or 500′ and the clip part 600. As illustrated in the graph of FIG. 12, it can be confirmed that the brightness is not significantly degraded in connection portions between the lighting fixtures such that uniformity in overall illumination is maintained.

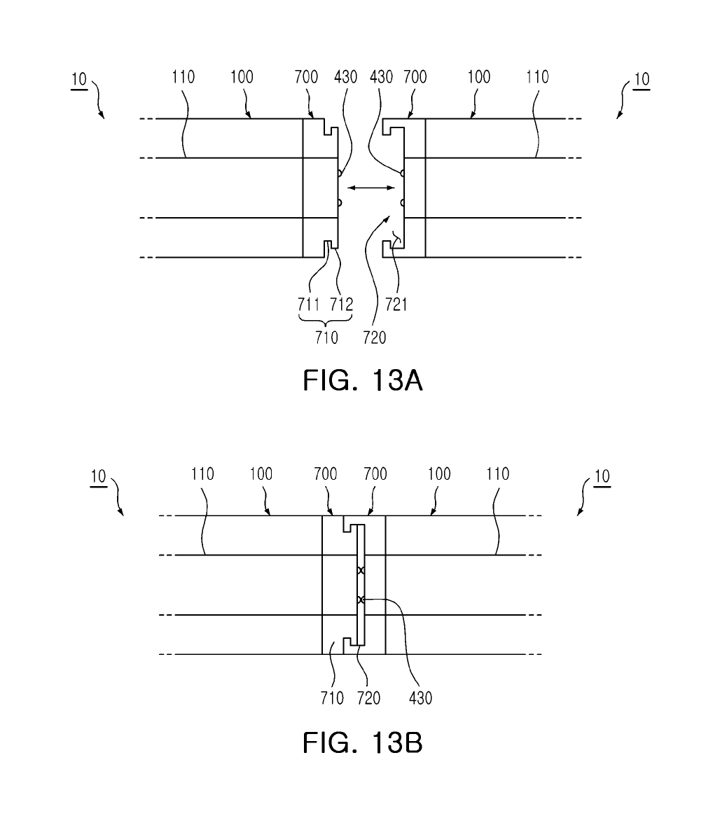

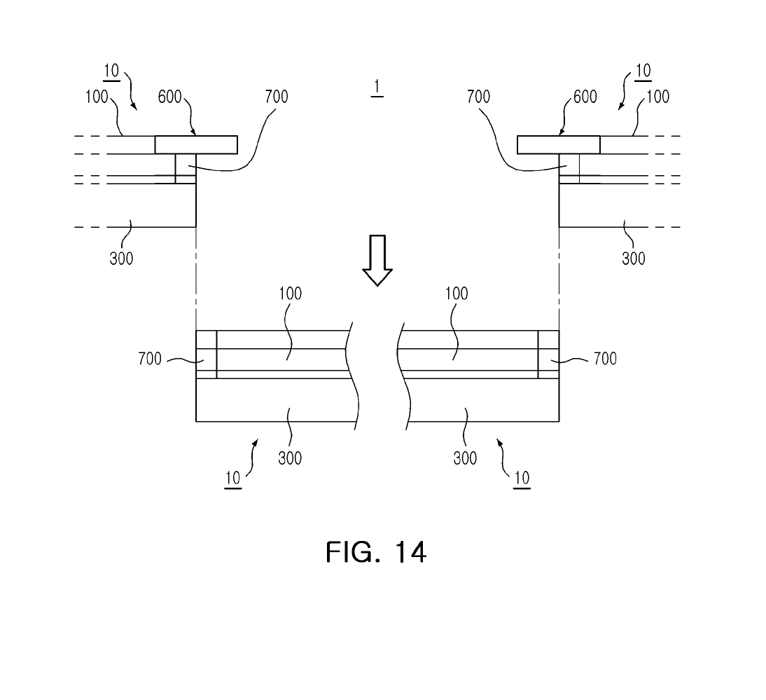

With reference to FIGS. 13 and 14, a lighting fixture according to another embodiment will be described. FIGS. 13A and 13B are schematic planar views of a lighting system in which a plurality of lighting fixtures are interconnected. FIG. 14 is a schematic side view illustrating lighting fixtures separated from the lighting system of FIG. 13.

A configuration of lighting fixtures shown in FIGS. 13 and 14 is substantially similar to embodiments described with reference to FIGS. 1 to 11 in terms of basic structure. However, a structure of a connector part in the embodiment of FIGS. 13 and 14 is different from the connector part illustrated in the embodiments of FIGS. 1 to 11. Duplicative descriptions of elements common in the various embodiments will be omitted, and the configuration of the connector part is thus principally described below.

As shown in FIGS. 13 and 14, a lighting fixture 10 according to the present embodiment may include a frame 100 provided with a short protrusion 110 having a step structure formed in an outer/upper surface of the frame 100. At least one light source 200 is disposed inside the frame 100, a cover 300 is coupled to the frame 100 to cover the at least one light source 200, connector parts 700 are respectively provided on both ends of the frame 100, and at least one clip part 500 is engaged with the short protrusion 110 to be detachably fastened to the frame 100.

The connector parts 700 may be coupled to respective distal end portions of the frame in the length direction thereof, and may define a closed internal space of the frame 100 for receiving the light source 200 therein together with a pair of reflective parts 130.

The connector part 700 may have a shape corresponding to a shape of a cross section of the frame 100 in the width direction of the frame 100, and may be formed of an electrically insulating material such as a resin.

The connector part 700 coupled to both distal end portions of the frame 100 may have one side provided with a male connector 710 and another side provided with a female connector 720 having a structure in which the female connector 720 can be engaged with the male connector 710 of an adjacent frame 100.

The male connector 710 may include a support portion 711 protruding laterally from the connector part 700, and a step portion 712 extending orthogonally to the support portion 711 at an edge of the support portion 711, to have an overall protrusion structure having the shape of a T.

The female connector 720 may include a groove portion 721 having a shape corresponding to and complementary to the shape of the support portion 711 and the step portion 712 of the male connector 710, such that the support portion 711 and the step portion 712 of the male connector 710 can be inserted into the groove portion 721 of the female connector 720 to thereby be fixed thereto.

Therefore, the plurality of lighting fixtures 10 may be easily connected to one another by employing a scheme in which the male connector 710 is insertedly inserted into and fixed to the female connector 720 while both mechanically and securely connecting the plurality of lighting fixtures.

The male connector 710 and the female connector 720 may be provided with an electrode pin 430 exposed to the outside. The electrode pin 430 provided with the male connector 710 and the electrode pin 430 provided with the female connector 720 may be respectively disposed on corresponding positions corresponding thereto.

Therefore, the male connector 710 of a lighting fixture 10 may be engaged with the female connector 720 of another lighting fixture 10 such that respectively exposed electrode pins 430 of the male connector 710 and of the female connector 720 may be electrically connected to each other.

As described above, the connector part 700 may enable the plurality of lighting fixtures 10 to be mechanically and electrically connected to one another. In particular, since the male connector 710 and the female connector 720 have a structure in which the male connector 710 can be insertedly fixed to the female connector 720 to be detachable therefrom, in a case in which a portion of the lighting fixtures 10 is not workable due to occurrence of a defect in a state in which the plurality of lighting fixtures 10 are connected to one another, in order to easily replace the lighting fixture having a defect with another lighting fixture 10, the corresponding lighting fixture 10 having a defect may be removed downwardly. Accordingly, it may be easy to manage the entire lighting system 1.

The clip part 600 may be simultaneously fastened to the respective frames 100 with regard to a pair of the lighting fixtures 10 connected to each other in a state in which the plurality of lighting fixtures 10 are connected in a length direction of the lighting fixture, such that the pair of lighting fixtures 10 may be firmly fixed to each other, with relative mechanical strength.

That is, at an interface in which two lighting fixtures 10 are connected to one another, the clip part 600 may be fastened to both of the lighting fixtures 10 such that the lighting fixtures 10 are connected relatively closely to one another. Accordingly, a seamless connection in which a gap at the interface between the two lighting fixtures 10 does not occur may be achieved.

As set forth above, according to embodiments, a lighting fixture capable of significantly reducing the occurrence of a dark portion in a connecting part between two lighting fixtures and using various fixing schemes applied thereto with respect to a location such as a ceiling to which a lighting fixture is fixed may be provided.

While the inventive concept has been shown and described in connection with embodiments, it will be apparent to those skilled in the art that modifications and variations can be made without departing from the spirit and scope of the present inventive concept as defined by the appended claims.

What is claimed is:

1. A lighting fixture comprising:
a frame including a short protrusion disposed in an outer surface of the frame, the short protrusion having a step structure;
at least one light source disposed inside the frame;
a cover coupled to the frame to cover the at least one light source;
a pair of cap parts, each including a coupling groove and supplying power to the at least one light source, and each disposed at a respective end of the frame; and
a terminal part having one end fastened to the coupling groove of one of the pair of cap parts, and having the other end protruding to the outside.

2. The lighting fixture of claim 1, wherein the terminal part of the lighting fixture is further fastened to a coupling groove of a different lighting fixture through the other end of the terminal part that protrudes to the outside, to thereby connect the lighting fixture and the different lighting fixture to one another.

3. The lighting fixture of claim 1, further comprising at least one clip part engaged with the short protrusion and configured to be detachably fastened to the frame.

4. The lighting fixture of claim 3, wherein the short protrusion protrudes from an upper surface of the frame and extends in a length direction of the frame, and the clip part includes a protrusion caught by and fixed to the short protrusion provided in the length direction of the frame.

5. The lighting fixture of claim 4, wherein the clip part includes a first surface disposed above the short protrusion when the clip part engages the short protrusion, and a second surface bent away from both ends of the first surface and extending therefrom.

6. The lighting fixture of claim 5, wherein the second surface includes a pair of second surfaces extending away from the first surface in parallel with each other and each having a protrusion formed on an inner surface facing the other second surface of the pair.

7. The lighting fixture of claim 5, further comprising a third surface bent outward from respective edges of the pair of second surfaces so as to be disposed along the upper surface of the frame when the clip part engages the short protrusion.

8. The lighting fixture of claim 1, wherein the frame includes:
a base part having one surface on which the short protrusion is disposed and another surface on which the light source is disposed; and
a reflective part bent from an outer edge of the base part and extended therefrom.

9. The lighting fixture of claim 8, wherein the short protrusion has a rail structure in which at least one pair of protrusions protrude symmetrically outward from opposite side surfaces of the short protrusion, and extends in the length direction of the base part.

10. The lighting fixture of claim 1, wherein each cap part includes:
the cap coupled to a respective distal end of the frame and having a coupling groove therein; and
an electrode pin included in the coupling groove and connected to the terminal part.

11. The lighting fixture of claim 1, wherein the light source includes at least one substrate and at least one light emitting device disposed on the substrate.

12. A lighting fixture comprising:
a frame including a short protrusion disposed on an outer surface of the frame, the short protrusion having a step structure;
at least one light source disposed inside the frame;
a cover coupled to the frame to cover the at least one light source;
a pair of connector parts each coupled to a respective distal end portion of the frame, and one connector part of the pair including a male connector and the other connector part of the pair including a female connector having a structure in which the female connector can be engaged with a male connector of another lighting fixture; and
a clip part engaged with the short protrusion so as to detachably fasten the clip part to the frame.

13. The lighting fixture of claim 12, wherein the male connector includes a support portion protruding laterally from the connector part and a step portion extending orthogonally to the support portion at an edge of the support portion, and the female connector includes a groove portion having a shape complementary to the shape of the support portion and the step portion of the male connector.

14. The lighting fixture of claim 12, wherein the male connector and the female connector each include an electrode pin disposed thereon and exposed to the outside, and the electrode pin of the female connector of the lighting fixture is engaged with the electrode pin of the male connector of the other lighting fixture such that the female connector and the male connector are electrically connected.

15. The lighting fixture of claim 12, wherein the clip part is simultaneously fastened to the frame of the lighting fixture and to the frame of the other lighting fixture, such that the lighting fixture and the other lighting fixture are fixed to each other.

16. A lighting system comprising:
first and second lighting apparatuses, wherein each of the first and second lighting apparatuses comprises:
a frame including a short protrusion disposed in an outer surface of the frame, the short protrusion having a step structure;
a light source disposed inside the frame; and
a pair of cap parts, each including a coupling groove and supplying power to the light source of the respective lighting apparatus, and each disposed at a respective end of the frame; and
a clip part engaged with the short protrusion of the first lighting apparatus and with the short protrusion of the second lighting apparatus, including a fixing hole for fastening the clip part to a structure, and configured to detachably fasten the frames of the first and second lighting apparatuses to each other and to the structure.

17. The lighting system of claim 16, wherein the short protrusion of each of the first and second lighting apparatuses protrudes from an upper surface of the frame of the respective lighting apparatus and extends in a length direction of the frame, and the clip part includes a protrusion caught by and fixed to the short protrusion of each of the first and second lighting apparatuses provided in the length direction of the frame.

18. The lighting system of claim 17, wherein the clip part includes a first surface disposed above the short protrusion of each of the first and second lighting apparatuses when the clip part engages the short protrusion of the first and second lighting apparatuses, and a second surface bent away from both ends of the first surface and extending therefrom.

19. The lighting system of claim 18, wherein the second surface includes a pair of second surfaces extending away from the first surface in parallel with each other and each having a protrusion formed on an inner surface facing the other second surface of the pair.

20. The lighting system of claim 18, further comprising a third surface bent outward from respective edges of the pair of second surfaces so as to be disposed along the upper surface of the frame of each of the first and second lighting apparatuses when the clip part engages the short protrusion of the first and second lighting apparatuses.
